(19) United States
(12) Patent Application Publication
(10) Pub. No.: US 2008/0286226 A1
(43) Pub. Date: Nov. 20, 2008

(54) POLYMERIC ENHANCEMENT OF PESTICIDE BAIT SPRAYS TO INCREASE RAINFASTNESS

(76) Inventors: William Toreld, III, Gainesville, FL (US); Ara Manukian, Gainesville, FL (US)

Correspondence Address: Beusse Wolter Sanks Mora & Maire, 390 N. ORANGE AVENUE, SUITE 2500, ORLANDO, FL, 32801, US

(21) Appl. No.: 12/059,013

(22) Filed: Mar. 31, 2008

Related U.S. Application Data
(60) Provisional application No. 60/921,343, filed on Mar. 31, 2007.

(51) Int. Cl. A01N 25/00

(52) U.S. Cl. 424/84

(57) ABSTRACT

An insecticide composition is provided for killing insects comprising a bait spray formulation comprising a bait component, an insecticide component, and an adjuvant effective to decrease the water solubility of the bait spray formulation upon drying of the bait spray formulation. Upon application to a target environment, the bait spray formulation will dry, typically via evaporation of at least a portion of the water contained in the original bait spray composition, leaving a residue which is substantially insoluble in water, and thus less prone to being washed-off by rain or irrigation.

### CROSS-REFERENCE TO RELATED APPLICATIONS

This application claims benefit under 35 U.S.C. §119(e)(1) of the Mar. 31, 2007, filing date of U.S. Provisional Application No. 60/921,343, the entirety of which is incorporated by reference herein.

### FIELD OF THE INVENTION

The present invention relates to bait spray formulations, and more particularly to bait spray formulations that provide increased weather resistance and field life after application of the bait spray formulations.

### BACKGROUND OF THE INVENTION

The Caribbean fruit fly, Anastrepha suspensa (Loew), has also been called the Greater Antilliean fruit fly, the guava fruit fly, and the Caribfly. It is a near relative of the Mexican fruit fly, Anastrepha ludens (Loew), and is one of several species of fruit flies which are indigenous to the West Indies and the larvae of which attack several kinds of tropical and subtropical fruits. For example, the flies are known to severely attack fruits such as guavas, roseapples, and Surinam cherries. Moreover, a particular strain has been found to be a pest of commercial citrus, mangoes, and peaches in Florida and other warmer climates.

To control the population of Caribbean fruit flies and other insects, bait sprays are applied to the affected or potentially affected crop by aerial application or by other means. Known bait sprays typically comprise an insecticide component and a bait component to attract the insect to the insecticide, which kills the insects. A major problem with using current bait sprays; however, is that they must be reapplied every 7 to 10 days, or sooner, because of their susceptibility to being washed off by rain or overhead irrigation. Besides the high cost of frequent repetitive applications, current treatment schedules require a substantial amount of insecticide. Further, frequent reapplication of bait sprays result in a significant increase in the amount of insecticides being put out into the environment. Because of rain and irrigation water run-off, the active pesticide agents used in the bait sprays ultimately contaminate surface and ground (drinking) waters. This is a major concern for citizens, political environmental groups, and governmental regulatory agencies (EPA, FDEP). Accordingly, there is a need for bait spray formulations having longer field longevities to reduce the number of applications needed to prevent insect infestation on commercial fruit crops or other vegetation.

### DETAILED DESCRIPTION OF THE INVENTION

The inventors have found that adjuvants, such as environmentally safe, inexpensive, natural and synthetic polymers, may be added to bait spray formulations comprising a bait component and an insecticide component to decrease the water solubility of the bait spray formulations relative to the bait spray formulations without the adjuvants upon drying of the bait spray formulations on a target surface. Upon application to a target environment, the bait spray formulation will dry, typically via evaporation of at least a portion of the water contained in the original bait spray composition, leaving a residue which is substantially insoluble in water, and thus less prone to being washed-off by rain or irrigation (hereinafter referred to as the compositions' “rainfastness”). In this way, the present invention prolongs the useful field life of bait sprays after application for the control of insects and reduces the frequency of reapplications of the bait sprays. By reducing the frequency of bait spray reapplications, substantial cost savings can be achieved. In addition, reducing the number of bait spray reapplications results in a significant reduction in the amount of pesticide agents being released into the environment. Further, the bait spray formulations of the present invention are at least as attractive to insects, including Caribbean fruit flies, as a standard bait spray, and the toxicant effect of the insecticide component of the bait sprays are not diminished.

In accordance with one aspect of the invention, there is provided a bait spray formulation comprising a bait component, an insecticide component, and an adjuvant effective to decrease a degree of water solubility of the bait spray formulation relative to the formulation without the adjuvant upon drying of the bait spray formulation. The bait component may be any component known in the art for attracting insects to the location of the bait component or for the insects to ingest the bait component, typically along with an insecticide. In one embodiment, the bait component is a composition that attracts Caribbean fruit flies. One suitable bait component for use in present invention comprises protein hydrosylates. Protein hydrosylates include mixtures of amino acids prepared by splitting a protein with acid, alkali or enzyme. Suitable commercially available bait sprays comprising protein hydrosylates include bait sprays sold under the names NuLure® and Naturalyte®. Alternatively, the bait component may be made from a wide range of natural and artificial food sources targeted for the pest insect, such as sugars, proteins, amino acids derived from plant extracts, fruits and vegetables. In addition, phagostimulants, aggregation pheromones or other semiochemicals can be added to the bait solution to increase attractiveness.

The present invention has surprisingly and advantageously found that the addition of an adjuvant to decrease the solubility of a bait spray to improve the rainfastness and field life of the bait spray has minimal to no effect on the attractiveness of the bait component to the insects. Nevertheless, one skilled in the art would readily appreciate that the bait component as discussed herein could be removed from the formulations of the present invention if it is deemed that an attractant is not required for a particular application. If an attractant is utilized, then the present invention offers a significant advantage of improving rainfastness and field life without affecting the properties of the bait component.

The insecticide component may be any suitable insecticide known to be effective in reducing a population of insects. In one embodiment, the insecticide component is effective in killing or reducing a population of Caribbean fruit flies. In a particular embodiment, the insecticide component comprises organophosphates. Organophosphates is a generic term referring to insecticides containing phosphorus and may also be referred to as organic phosphates, phosphorus insecticides, nerve gas relatives, phosphates, phosphate insecticides, and phosphorus esters or phosphoric acid esters. Organophosphates are all derived from phosphoric acid and are generally the most toxic of all pesticides to vertebrate animals. Typically, they exert their toxic action by inhibiting the cholinesterase enzymes of the nervous system, which results in the accumulation of acetylcholine. This interferes with neuromuscular junctions producing rapid twitching of the voluntary muscles and eventually paralysis. Generally, there are three types of organophosphates: aliphatic, phenyl, and heterocyclic derivatives.

Aliphatic derivatives are simple phosphoric acid derivatives bearing short carbon chains. Exemplary aliphatic derivatives include malathion, trichlorfon, monocrotophos, dimethoate, dicrotophos, oxydemetonmethyl, disulfoton, dichlorvos, mevinphos, methamidophos, and acephate. Phenyl derivatives contain a benzene ring with one of the ring hydrogens displaced by attachment to phosphorus while other ring hydrogens are typically displaced by other functional groups. These are generally more stable than the aliphatic organophosphates. As a result, their residues are relatively long lasting. Exemplary phenyl derivatives include parathion, stirofos, profenophos, sulprofos, and isofenphos. Heterocyclic derivatives contain ring structures that are composed of different or unlike atoms. One or more of the carbon atoms is displaced by oxygen, nitrogen, or sulfur and their rings may have three, five, or six atoms. Exemplary heterocyclic organophosphates include diazinon, azinphosmethyl, chlorpyrifos, methidathion, phosmet, and dialifor. In one particular embodiment, the insecticide is malathion, an organophosphate parasympathomimetic, which binds irreversibly to cholinesterase. Malathion has been shown to be particularly useful in exterminating Caribbean fruit fly populations.

In one particular embodiment, the bait spray formulation comprises a mixture of NuLure®, a protein bait spray, and malathion. In one embodiment, the NuLure® and malathion provided as a mixture that is from about 70% to about 90% NuLure®, such as an 80/20% mixture by weight of NuLure® and malathion respectively.

Alternatively, the insecticide may be any known insecticide such as carbamates, sodium channel modulators/voltage dependent sodium channel blockers, pyrethroids such as DDT, oxadiazines such as indoxacarb, acetylcholine-receptor agonists/antagonists, acetylcholine-receptor-modulators, nicotine, bensultap, cartap, chloronicotyinyls such as acetamiprid, clothianidin, dinotefuran, imidac loprid, nitenpyram, nithiazine, thiacloprid, and thiamethoxam, spinosyns such as spinosad, cyclodiene organochlorines such as camphechlor, chlordane, endosulfan, gamma-HCH, HCH, heptachlor, lindane, methoxychlor, fiproles such as acetoprole, ethiprole, fipronil, vaniliprole, chloride-channel, 6.1 mectins such as avermectin, emamectin, emamectin-benzoate, ivermectin, and milbemycin, juvenile-hormone mimics such as diofenolan, epofenonane, fenoxycarb, hydroprene, kinoprene, methoprene, pyriproxyfen, and triprene, ecdysone agonists/disruptors, diacylhydrazine, chromafenozide, halofenozide, methoxyfenozide, tebufenozide, chitin biosynthesis inhibitors, benzoylureas such as bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron, buprofezin, cyromazine, oxidative phosphorylation inhibitors, ATP disruptors, diafenthiuron, organotins such as azocyclotin, cyhexatin, fenbutatin-oxide, pyrroles such as chlorfenapyr, dinitrophenols such as binapacryl, dinobuton, dinocap, DNOC, site-I electron transport inhibitors, METI's such as fenazaquin, fenpyroximate, pyrimidifen, pyridaben, tebufenpyrad, tolfenpyrad, hydramethylnon, dicofol, rotenone, acequinocyl, fluacrypyrim, spirodiclofen, spiromesifen, tetramic acids, carboxamides such as flonicamid, octopaminergic agonists such as amitraz, magnesium-stimulated ATPase inhibitors such as propargite, BDCA's such as N2-[1,1-dimethyl-2-(methylsulfonyl)ethyl]-3-iodo-N1-[2-methyl-4-[1,2,2,2-tetrafluoro-1-(trifluoromethyl)ethyl]phenyl]-1,2-benzene, nereistoxin analogues such as thiocyclam hydrogen oxalate, and thiosultap sodium, biological agents, hormones or pheromones such as azadirachtin, bacillus spp., Beauveria spp., codlemone, metarrhizium spp., Paecilomyces spp., Thuringiensin, Verticillium spp., fumigants such as aluminium phosphide, methyl bromide, and sulfuryl fluoride, selective antifeedants such as cryolite, flonicamid, and pymetrozine, and mite growth inhibitors such as clofentezine, etoxazole, and hexythiazox. In another particular embodiment, the insecticide component is spinosad, which is particularly effective as an insecticide for Caribbean fruit flies.

Known bait sprays suffer from the problem of being washed away by rain or irrigation such that reapplication of the bait spray formulations may be required every 7 to 10 days. Because of this lack of rainfastness or longevity, repeated application of known bait sprays is necessary to insure the effectiveness of the bait spray formulations in controlling Caribbean fruit fly infestations prior to harvest, significantly increasing the growers production cost to bring their crop to market. In accordance with one aspect of the invention, an adjuvant is added to a bait spray comprising a bait component and an insecticide to decrease the solubility of the bait spay formulation upon drying and to prolong the useful field life of the bait spray after application for the control of insects, such as the Caribbean fruit fly. The bait spray formulations of the invention described herein including the adjuvant are an environmentally safe, inexpensive approach to decreasing the water solubility of bait sprays, for example protein hydrolysate fruit fly bait sprays, such as a commercially available NuLure®®/malathion formulation (also alternatively referred to herein as NL/malathion) used in the Florida Caribbean Fruit Fly Protocol Program.

Typically, the adjuvant is effective to decrease a water solubility of the bait spray formulation relative to the bait spray formulation without the adjuvant upon drying of the bait spray formulation at ambient temperature, such as by evaporation. Alternatively, the water solubility of the bait spray formulation with the adjuvant may be decreased at a temperature above or below ambient relative to the bait spray formulation without the adjuvant. In one embodiment, the adjuvant is provided in the bait spray formulation at a concentration in the range of from about 5% to about 70% by total dried weight of the bait spray formulation. In this way, when the bait spray formulations are applied to the subject crops to control insect infestation, the field longevity and ability of the bait spray formulation to withstand wind, rain, and the like, are increased such that the bait spray formulation is maintained on the subject plant or tree (crop) while also maintaining its efficacy.

In one embodiment, the adjuvant is water soluble when mixed with the bait component and the insecticide component to form the bait spray formulation, and is thereafter substantially water insoluble once water is removed from the mixed bait spray formulation by sunlight, wind, heat, and evaporation. Optionally, heat may be applied during mixing to solubilize the adjuvant in the bait spray formulation. In this way, a relatively insoluble bait spray formulation is provided on the target crop upon drying of the bait spray formulation that is substantially resistant to being washed away. Poly(viny alcohol) (PVA), carboxymethyl cellulose (CMC), and starches function in the above-described manner. Thus, in one embodiment, the adjuvant may be selected from the group consisting of a starch, carboxymethyl cellulose (CMC), poly(vinyl alcohol) (PVA), and combinations thereof. When the adjuvant includes PVA, the PVA may be at least about 99% hydrolyzed. PVA is manufactured as poly(vinyl acetate). The acetate groups are converted to —OH (alcohol) groups via hydrolysis. PVA which is greater than approximately 98% hydrolyzed is typically know as “fully hydrolyzed” PVA. Fully hydrolyzed PVA is known to be insoluble in water unless heated to greater than approximately 60° C. Partially (i.e. <90%) hydrolyzed PVA is generally soluble in water even without heating, and thus less useful in the practice of this invention.

PVA is a particularly suitable polymer for use in the present invention. PVA is a water-soluble polymer that requires heating to approximately 60° C. in order for it to dissolve in water. This is the main polymer ingredient that was used to stabilize the bait spray formulations. As the solution in which the PVA is contained dries, the PVA solidifies, and cannot be redissolved without heating. Malathion does not appear to substantially dissolve in solid PVA (or vice-versa), and removal of water from a mixture of malathion and PVA solution likely results in formation of heterogeneous phases with the liquid malathion dispersed in a solid PVA matrix. High molecular weight PVA having a molecular weight of from about 50,000 to about 250,000 may be utilized in the present invention; however, a lower molecular weight PVA having a molecular weight of from about 10,000 to about 50,000 may also be utilized in order to allow for addition of higher PVA concentration without giving excessively high viscosity. Because the PVA must first be dissolved in water, then added to the bait spray formulation as a solution, significant dilution (approximately 2-5×) of the original formulation (i.e., the 80/20 NuLure/malathion) is typically required.

In another embodiment, the adjuvant is a water insoluble polymer or wax, which is initially soluble, dispersable, or miscible when added and mixed with a bait component and an insecticide component. Suitable water insoluble polymers for use in the present invention include one or more polymers selected from the group consisting of poly(tetramethylene oxide), poly(caprolactone), a poly(acrylic acid) derivatives, paraffin wax, bee's wax and combinations thereof. Other useful polymers would be those that are soluble in, dispersable in, or miscible with the bait spray formulation or a component thereof. Upon application to a target environment, the bait spray formulation will dry via evaporation of at least a portion of the water contained in the original bait spray composition, leaving a residue which is substantially insoluble in water, and thus less prone to being washed-off by rain or irrigation.

In one embodiment, the water insoluble polymer for addition to the bait spray formulation is poly(tetramethylene oxide) (PTMO). PTMO is a low melting point, water-insoluble polymer that looks and feels like wax. When added to the bait spray formulation, the PTMO may act to stabilize the insecticide component of the formulation. For example, in one particular embodiment, the adjuvant is poly(tetramethylene oxide), the insecticide component is malathion, and the ratio of poly(tetramethylene oxide) to malathion is from about 1:5 to about 1:1, and preferably 1:1 to take advantage of PTMO's properties. Malathion and PTMO are mutually soluble and miscible, and a 50/50 mixture is a solid with a melting point close to room temperature. The melting point of this mixture can be adjusted by changing the ratio of the two components, or by changing the molecular weight of the PTMO. Incorporation of malathion into the solid PTMO prevents loss of the insecticide component by exposure to water and slows the evaporation of the insecticide component. The insecticide component is believed to remain mobile within the matrix and can diffuse to the surface to provide the expected toxicant effect. The waxy hydrophobic character of the PTMO component is also believed to increase adhesion of the bait spray composition to citrus foliage, which has a similar surface texture. It also provides an added degree of rainfastness to the entire mixture. Thus, PTMO provides significant advantages and is a particularly useful adjuvant in the present invention.

It is contemplated that any of the adjuvants described above may be effective to increase a viscosity of the bait spray formulation. For example, PTMO or PVA are particularly useful for increasing a viscosity of the bait spray formulations of the present invention. As a result of the increase in viscosity, the adjuvant is likely to increase the ability of the bait spray formulation to be maintained on the applied substrate, i.e. crops, after application. However, additionally, any known component for increasing a viscosity of the mixture may be further added along with an adjuvant described herein.

In another embodiment, the adjuvant comprises a combination of PVA and PTMO. Bait spray formulations containing polymer (PVA and PTMO) have a significantly higher viscosity than the baseline NL-malathion composition. This is expected to enhance retention of the bait spray formulation on a target crop surface as the applied droplets will not be as prone to run and drop off the target surface. It also has the advantage of retarding phase separation in the micro-heterogeneous composition and may act as an emulsifier for the bait spray formulation. Some minor adjustments or modifications to the spray apparatus or techniques may be necessary in order to accommodate the higher viscosity material.

The bait spray formulations of the present invention may eventually solidify or gel upon standing, particularly when stored in bulk quantities. Typically, however, most bait spray formulations of the present invention will remain in a liquid state for a useful period of at least several hours, if not days. Continuous mixing may prevent gel formation. PVA solutions can also form reversible gels with various compounds (borates, for instance), and these gels are generally reversible, becoming liquid at acidic pH. Thus, in accordance with another aspect of the present invention, an organic acid, such as acetic acid or citric acid, may be added to any of the embodiments of the bait spray formulation disclosed herein in an attempt to retard gelling of the bait spray formulations. In one embodiment, citric acid is provided to the bait spray formulation in an amount ranging from about 0.2% to about 5% by weight. In a particular embodiment, about 1% citric acid by weight is provided to the bait spray formulation. Additionally, in another embodiment, the gelling of the formulations can be retarded by addition of other appropriate acidic reagents, by adjustment of the molecular weight, or by adjustment of the extent of hydrolysis of the PVA component. Otherwise, the bait spray formulations likely need to either be used promptly after preparation, or subjected to continuous agitation until use. However, the auto-gellation property is desirable in that it results in prolonged adhesion, tenacity, durability, and rainfastness upon application to a target environment and drying of the bait spray formulation.

The ingredients of the composition are selected to be consistent with the physical properties of the active ingredient, mode of application and environmental factors, such as plant type and outdoor temperature. Useful formulations may also include solids such as dusts, powders, granules, pellets, tablets, films, and the like that may be water-dispersible (“wettable”) or water-soluble. Surfactants, including ionic and nonionic surfactants, and combinations thereof, may be added to the formulations to further increase the likelihood that the bait spray formulations will adhere to the target surface.

The compositions of the present invention may be prepared as dispersions, mixtures, solutions, suspensions, or emulsions. Mixtures and solutions may be prepared by mixing the components of the composition by any suitable method known in the art. Suspensions may be prepared by wet milling or by any other known method in the art. Emulsions may be prepared by mixing the components by any suitable method in the art, and typically include a surfactant as discussed above.

Once prepared, the insecticide compositions are typically applied to the targeted crop by any suitable method known in the art such as by spraying or aerially dispensing the bait spray formulations. When applied aerially, the bait spray formulations are applied to commercial fruit crops at a total rate of 12 ounces per acre with a target droplet size of from 4-6 mm.

The formulations described above and demonstrated in the following examples were selected based on initial series of experiments wherein various compositions were applied to live citrus leaves, and evaluated qualitatively for adhesion and rainfastness. It was found that the bait spray formulations comprising a polymer adjuvant had significantly improved rainfastness compared to the baseline NuLure®/malathion composition without a polymer adjuvant. All of the polymer formulations tested showed significantly improved rainfastness based on visual observation of the amount of treatment remaining. In fact, the baseline NuLure®/malathion composition was easily washed away with only minor spraying, leaving no visible residue. In the case of the polymer formulations, it was clear that the material did not appreciably dissolve. The addition of PTMO to the formulations also enhanced rainfastness and adhesion to some extent.

### EXAMPLE 1

To determine the efficacy of several adjuvants in increasing the rainfastness of bait sprays, several test polymer adjuvants were added to a standard NL/malathion bait spray. The modified bait sprays were applied drop-wise to a holding matrix, aged, and presented to the flies over time. These preliminary tests were conducted to determine which agent among the following would be most effective as an adjuvant in a bait spray formulation.
I. NuLure®/malathion Standard Spray (Control): (15 ml NL/M+15 ml water)
II. NuLure®/malathion with PVA: (15 ml NL/M+15 ml PVA)
III. NuLure®/malathion with PVA+CA: (15 ml NL/M+15 ml PVA+2 ml CA)
IV. NuLure®/malathion with PTMO+PVA: (15 ml NULURE®/M-PTMO+15 ml PVA)
V. Check: Adult Food (Yeast Hydrolysate/Sugar blocks)

Note that the final NuLure®, and malathion concentrations in each solution were approximately identical. Also note that the control (treatment 1) is diluted by 50% compared to its normal use level to compensate for volume of polymer solution added to the other treatments.

In order to prepare the above samples, the following stock solutions were prepared:

N-M: A mixture of 40 ml NuLure® and 10 ml malathion (97% purity) was prepared and mixed well using a vortex mixer.

PVA: An aqueous solution of 5 wt % high molecular weight (mw) poly(vinyl alcohol) (PVA), (Elvanol® 70-62, fully hydrolyzed available from DuPont™) was prepared by dissolving the PVA powder in hot water with stirring.

N-M-PTMO: Two grams of PTMO (mw 2900) was dissolved in 10 mL of malathion by stirring in a heated water bath. 38 mL of NuLure® was added and mixed well using a vortex mixer.

CA: 10% citric acid (aqueous).

These solutions were pipetted onto 3×5 “dye cards as 6 mm droplets and stored outside, under shelter, in a shaded area during the hottest and wettest part of the summer for up to 21 days (Table 1) in Gainesville, Fla. All polymer solutions solidified within 30 minutes of application; however, the baseline NuLure®/malathion composition remained fluid throughout the experiment, presumably due to the high humidity and higher than normal initial water content.

Caribbean fruit fly pupae were obtained from the Caribbean fruit fly colony maintained by the Bio-Control Rearing Facility, FDACS, Gainesville, Fla. Approximately 50 ml (50/50 male to female ratio) were placed into each of two 30×40×30 cm Plexiglas cages ventilated with a fiberglass mesh top. Twenty-two grams of food (protein blocks) and a 474 ml container of water were placed in each cage. The water container was equipped with a lid with a hole, which accommodated two 9.8 mm diameter dental wicks, and provided drinking water to the flies. When the flies were at least 5 days post-emergence and sexually mature, they were protein deprived for 24 hr prior to treatment. A vacuum aspirator was used to gently collect the flies from the large cages. They were held overnight in 474 ml cups with a screened lid. Sugar water agar (15%) was placed on the top of the mesh screen to provide water to the flies overnight.

For this test, the treatments (bait spray formulations) were made as noted above in the treatment section by Analytical Research Systems, Inc. All of the bait spray formulations were made at the same time, and introduced into the testing cages over time (initial-time 0, 8, 14 and 21 days). Observations on mortality of the flies were made at 8, 24, and 48 hours after each release. The cards not being used in the tests were stored outside in ambient temperatures and relative humidity in a tiered system in covered screened cages in order to “age” them. This was done to determine longevity and efficacy of the insecticide component and the bait component. To simulate field conditions in the cages, dye cards were hung in each cage. Four cages were used as replicates, with 50 flies released per cage (25 male/25 female) over time. For this test, 0.21 ml (210 μl) of the bait spray formulation material was applied as seven 30 μl drops per card for each replicated treatment per cage.

The flies were released into standardized 24″×24″×12″ screened, aluminum framed cages from the holding cups. Bait spray formulations were applied to the holding matrix (paper cards), and introduced into the testing cages over time (Day 0-initial, 8, 14 and 21). New cohorts of Caribbean fruit fly were introduced into the cages at each time interval. Observations of mortality were made and recorded after each weekly release at 8, 24, 48 and 72 hrs or until all flies were dead at day 0 (initial), and after 8, 14 and 21 days of storage. The dead flies were aspirated out prior to the next release. New flies were released into the cages for each testing time as indicated above. The observation area was maintained between 78° F. and 81° F. with a relative humidity between 50-60%, continuous lighting was provided by cool-white fluorescent ceiling fixtures (Lux˜300 inside Plexiglas cages). The results were as follows:

TABLE 1
(Mortality of Caribfly after exposure to bait sprays)

| Day | Treatment | 8 hrs | 24 hrs | 48 hrs | 72 hrs |
|---|---|---|---|---|---|
| Initial | Malathion/NuLure ® | 86 | 98 | 100 | 100 |
| Initial | Formulation II | 90 | 97 | 100 | 100 |
| Initial | Formulation III | 88 | 96 | 100 | 100 |
| Initial | Formulation IV | 95 | 99 | 100 | 100 |
| Initial | Check (V) | 1 | 2 | 2 | 2 |
| 8 | Malathion/NuLure ® | 71 | 97.5 | 100 | 100 |
| 8 | Formulation II | 89 | 99 | 100 | 100 |
| 8 | Formulation III | 79.5 | 94 | 100 | 100 |
| 8 | Formulation IV | 90.5 | 100 | 100 | 100 |
| 8 | Check (V) | 3 | 7.5 | 10 | 10 |
| 14 | Malathion/NuLure ® | 6 | 75 | 99 | 100 |
| 14 | Formulation II | 15 | 79 | 100 | 100 |
| 14 | Formulation III | 8 | 76 | 98 | 100 |
| 14 | Formulation IV | 9 | 78 | 99 | 100 |
| 14 | Check (V) | 0 | 2 | 4 | 5 |
| 21 | Malathion/NuLure ® | 1 | 39 | 98 | 100 |
| 21 | Formulation II | 1.5 | 44 | 98 | 99.5 |
| 21 | Formulation III | 0.5 | 52 | 98 | 100 |
| 21 | Formulation IV | 2.5 | 54 | 97 | 100 |
| 21 | Check (V) | 0 | 1 | 2 | 5 |

As seen, there were no significant differences observed among any of the toxicant treatments at any one reporting period by day (initial, 8 d, 14 d or 21 d) or time (8, 24, 48 or 72 hrs) regarding mortality of the flies exposed to the different treatments. The only difference noted was when the material aged over time, it took longer for the flies to die after feeding as noted in Table 1. Compounds that had been aged for up to 8 days prior to bioassay resulted in ˜100% mortality after 24 hr exposure, whereas the material that had been aged for 14 to 21 days resulted in close to 100% mortality only after 48-72 hr exposure time. This indicates a breakdown in the toxicant material over time. Based on the results of this no-choice study, it is possible to say that none of the adjuvants tested exhibited any repellent effect or prevented the flies from ingesting the material.

In addition, while insect mortality studies showed no difference between the control and any of the polymer formulations when exposed to fruit flies in cages, a slight loss in potency of all samples was observed over time. This indicates that there is no negative effect of adding polymer to the baseline NuLure®/malathion mixture.

### EXAMPLE 2

The following experiments utilized a rain simulation chamber constructed of Plexiglas, which measured approximately 12″×12″×12″, with a perforated aluminum floor. A standard spray nozzle was centered in the top of the chamber. Water inlet pressure was regulated to 30 psi. The rainfall pattern inside the chamber was mapped using calibrated rain gauges. It was found that 5 minutes of exposure equated to one inch of rainfall. Because the rainfall intensity pattern was not uniform, test samples were placed only at the perimeter of the chamber floor—approximately one inch from the walls. In addition, the nozzle was rotated at regular intervals during rain exposure in order to ensure uniform coverage.

Test formulations were pipetted onto polyethylene slides that had been lightly roughened with sandpaper. It was found that polyethylene slides more closely matched the surface properties of citrus leaves with respect to retention of droplet size and shape. Each slide received six 30 μl droplets, which averaged approximately 6 mm in diameter. After application, the samples were generally dried overnight before being exposed to rain treatment. Drying conditions varied with respect to temperature and humidity, since the studies were conducted over a period of many months including hot/humid and cold/dry conditions. These conditions also match the wide range of actual use conditions that would be expected. It is noted that the conditions were identical for each sample within a given experimental set. The specific solution compositions studied were as shown in Table 2 below. The degree of rainfastness in Table 2 is based on visual estimation of residue, not insect mortality. Percentages are based on dry weight of the overall composition. Total solids represent the components listed with the remainder being water from either the NuLure® or polymer stock solutions:

TABLE 2
(Bait spray formulations for rainfastness testing)

| | Malathion | | | | | Rain- |
|---|---|---|---|---|---|---|
| Example | % dry | | | | total | fast- |
| # | weight | NL % | PTMO % | PVA % | solids | ness |
| NL/mal | 36 | 64 | na | na | 55% | poor |
| (control) | | | | | | |
| A | 24 | 42 | 24 | 10 | 42% | poor |
| C | 29 | 25 | 29 | 17 | 35% | good |
| D | 16 | 43 | 16 | 25 | 34% | good |
| E | 10 | 51 | 10 | 29 | 30% | medium |
| F | 5 | 57 | 5 | 32 | 28% | poor |
| G | 2 | 56 | 0 | 38 | 19% | good |
| H | 23 | 40 | 23 | 14 | 36% | medium |
| I (02/13) | 20 | 35 | 20 | 25 | 27% | good |

### EXAMPLE 3

Samples utilized in this experiment included compositions described in Examples A and C from Table 2. In addition, NuLure®/malathion solutions (no added polymers) diluted to approximately the same solids loading as the material of Examples A and C from Table 2 were also prepared. This was done in order to keep the overall level of bait and insecticide identical for all samples; however, it was observed that these samples washed-off in a matter of seconds (<10 seconds exposure in simulated rain chamber) leaving no visible residue, and thus were not tested. In subsequent experiments (see below), comparisons of polymer-enhanced formulations to undiluted NuLure®/malathion were made; however, amounts (number of drops per slide) were adjusted in order to keep overall amounts of bait and toxicant equal (rather than equal concentrations). Another sample (material of Example B) was prepared that was identical in composition to the material of Example A, but containing a small amount of Pluronic F88 surfactant. This composition was observed to be less rain-fast than the material of Example A, and thus was not tested. The following rain exposures were used: 1 minute (=0.2 inches), 5 minutes (=1 inch), 30 minutes (=6 inches), and 100 minutes (=20 inches). The 1, 5, and 30 minute samples were selected for evaluation using the insect assay.

The main difference between the materials of Examples A and C is that A contains more NuLure® and less PVA than the material of Example C. Even though the material of Example A has a higher solids content, the material of Example C clearly showed the best retention of applied formulation after rain treatment. The efficacy of the bait spray formulations on the mortality (%) of Caribbean fruit flies after exposure to polymerized bait sprays for 1, 5, or 30 minutes (0.2, 1, or 6 inches respectively) is summarized below in Table 3. Very little difference in activity is observed, despite the substantially higher retention of material for Example C compared to the material of Example A.

TABLE 3
(Mortality of Caribfly after exposure to bait sprays)

| | | A | A | A | C | C | C |
|---|---|---|---|---|---|---|---|
| Time (hrs) | Check | (0.2 in) | (1 in) | (6 in) | (0.2 in) | (1 in) | (6 in) |
| 2 | 0 | 17 | 24 | 1 | 27 | 28 | 3 |
| 4 | 1 | 29 | 29 | 6 | 37 | 33 | 10 |
| 8 | 1 | 59 | 37 | 17 | 61 | 59 | 27 |
| 24 | 2 | 92 | 85 | 65 | 93 | 90 | 62 |
| 48 | 3 | 99 | 100 | 99 | 100 | 100 | 99 |

### EXAMPLE 4

In this experiment, Compositions D, E, and F from Table 2 were tested. Again, each slide received six 30 μL droplets of polymer-modified bait spray composition. Rain exposures of 10 minutes (about 2 inches) and 60 minutes (about 12 inches) were tested. The key variable in this experiment was malathion content which was substantially reduced compared to the baseline NuLure®/malathion control composition. The material of Example F contained less than 1/7 the amount of malathion compared to the control. PTMO was used at a 1:1 ratio with malathion. The ratio of PVA to NuLure® was kept constant. Table 4 below summarizes the mortality (%) of Caribbean Fruit Flies after exposure to polymerized bait sprays. The results show a highly effective kill, even at substantially reduced malathion levels.

TABLE 4
(Mortality of Caribfly after exposure to bait sprays)

| Time | | D | D | E | E | F | F |
|---|---|---|---|---|---|---|---|
| (hrs) | Control | (2 in) | (12 in) | (2 in) | (12 in) | (2 in) | (12 in) |
| 2 | 4a^{z} | 6a | 1a | 29a | 2a | 8a | 2a |
| 4 | 4a | 12a | 1a | 32a | 2a | 12a | 4a |
| 8 | 4b | 23ab | 9ab | 46a | 12ab | 27ab | 10ab |
| 24 | 10c | 78ab | 77ab | 91a | 84ab | 88ab | 73b |
| 48 | 16b | 100a | 99a | 100a | 99a | 100a | 99a |

^{z}Means within a row followed by the same letter are not significantly different using Tukeys HSD Test (0.05)

### EXAMPLE 5

The material of Example G from Table 2 was used in this test in order to evaluate an even lower level of malathion (only 1/18 that of the baseline composition). The baseline 80/20 NuLure®/malathion composition was also tested. This time, no additional water was added due to lack of solidification in previous experiments. Again six 30 μL droplets were used on each slide. The material of Example G was exposed for 5 minutes (1 inch) and for 120 minutes (24 inches), while the NuLure®/malathion control was exposed for 5 minute (1 inch). The retention of the material of Example G was excellent, even after 24 inches of simulated rainfall. The baseline NuLure®/malathion composition (no added polymer) was substantially removed by only 1 inch of simulated rainfall. Table 5 below shows the mortality (%) (+S.D.) of Caribbean fruit flies exposed to the bait spray formulations.

TABLE 5
(Mortality (% + S.D) of Caribfly after exposure to bait sprays)

| Treatment | 2 hr | 4 hr | 8 hr | 24 hr |
|---|---|---|---|---|
| control | 0.00 ± 0.00 a^{z} | 0.00 ± 0.00 a | 0.00 ± 0.00 a | 0.00 ± 0.00 b |
| G1-24 in | 0.00 ± 0.00 a | 0.00 ± 0.00 a | 0.00 ± 0.00 a | 0.40 ± 0.89 b |
| G2-1 in | 0.00 ± 0.00 a | 0.00 ± 0.00 a | 0.00 ± 0.00 a | 1.20 ± 1.10 b |
| NL/mal -1 in | 0.00 ± 0.00 a | 0.00 ± 0.00 a | 1.20 ± 1.79 a | 12.4 ± 10.4 a |

^{z}Means in a column followed by the same letter are not significantly different using Tukeys HSD, α = 0.05.

### EXAMPLE 6

In the following test, the typical ratio of NuLure® to malathion (about 1.75:1) was used in the polymer formulation (Composition H—see Table 2). In addition, the baseline NuLure®/malathion composition was tested without added polymer. In this experiment, an attempt was made to keep the overall applied amount of NuLure® and malathion constant across all samples (with and without polymer). Thus, for the polymer sample (Composition H), nine 30 μL droplets were used, while for the baseline NuLure®/malathion formulation only four 30 μL droplets were applied to each slide. Rainfall amounts were 5 minutes (about 1 inch) and 25 minutes (about 5 inches). NuLure®/malathion (NL/Mal) with no added polymer was substantially removed after only 1 inch rain exposure, whereas the polymer Composition H remained substantially intact, even after 5 inches of simulated rain exposure. However, Composition H did appear to be less durable than Composition G described above. Table 6 below shows the mortality (%) (+S.D.) of Caribbean fruit flies exposed to the aforementioned bait spray formulations.

TABLE 6
(Mortality (% + S.D) of Caribfly after exposure to bait sprays)

| Treatment | 2 hr | 4 hr | 8 hr | 24 hr | 48 hr | 72 hr | 96 hr |
|---|---|---|---|---|---|---|---|
| control | 0.00 ± 0.00 a^{z} | 0.00 ± 0.00 a | 0.00 ± 0.00 a | 3.50 ± 4.12 a | 10.0 ± 10.6 b | 15.0 ± 11.6 b | 18.5 ± 11.7 b |
| NL/Mal- | 0.00 ± 0.00 a | 0.00 ± 0.00 a | 1.50 ± 1.00 a | 22.5 ± 21.8 a | 49.5 ± 34.2 a | 64.5 ± 36.6 a | 71.0 ± 31.4 a |
| 1 in | | | | | | | |
| NL/Mal - | 0.00 ± 0.00 a | 0.00 ± 0.00 a | 0.50 ± 1.00 a | 1.00 ± 1.15 a | 9.50 ± 6.61 b | 15.5 ± 10.5 b | 46.0 ± 33.7 ab |
| 5 in | | | | | | | |
| Polymer | 0.00 ± 0.00 a | 0.00 ± 0.00 a | 0.50 ± 1.00 a | 18.0 ± 9.66 a | 42.5 ± 6.19 ab | 62.0 ± 13.0 a | 71.5 ± 11.5 a |
| H - 1 in | | | | | | | |
| Polymer | 0.00 ± 0.00 a | 1.00 ± 1.15 a | 1.50 ± 1.00 a | 14.0 ± 3.65 a | 32.0 ± 6.73 ab | 57.5 ± 4.43 a | 68.0 ± 4.32 a |
| H - 5 in | | | | | | | |

^{z}Means in a column followed by the same letter are not significantly different using Tukeys HSD, α = 0.05.

### EXAMPLE 7

In the following test, the polymer composition was varied to increase the relative amount of PVA over that which was used in the previous experiment (See Table 2—Composition I). Again, the ratio of NL to malathion was kept constant, and the total amount of solids applied was kept equal (2 drops baseline NuLure®/malathion vs. 7 drops composition 1). Rain exposure of 5 minutes (=1 inch) and 25 minutes (=5 inches were utilized). The composition was observed to be more durable than the previous composition (Composition H). The samples were tested using the insect bioassay set forth in Examples 1-2, and then retested after storage for one week in order to demonstrate extended durability of the composition. Results are shown in Table 7A and 7B.

It was observed that the polymer-enhanced bait spray formulation was clearly more effective than the baseline NuLure®/malathion composition with no added polymer after 24 hours. Furthermore, efficacy was retained after one additional week of storage. The observed high levels of kill for the NuLure®/malathion samples after 48 hours were puzzling, given the fact that no visible residue was observed for these samples, particularly at the higher simulated rain exposure (5 inches). It was postulated that the polyethylene slides were capable of absorbing and retaining malathion. In order to test this, an additional experiment was performed using glass slides in Example 8. Previously, the use of glass slides allowed the applied droplets of NuLure®/malathion to spread and coalesce; however, it was found that by using the full-strength NuLure®/malathion composition (undiluted), and by using less drops per slide (only 2), that separate droplets could be maintained.

TABLE 7a
(Mortality (% ± S.D) of Caribfly after exposure to bait sprays)

| Treatment | 2 hr | 4 hr | 8 hr | 24 hr | 48 hr | 72 hr | 96 hr |
|---|---|---|---|---|---|---|---|
| control | 0.00 ± 0.00 a^{z} | 0.00 ± 0.00 a | 0.00 ± 0.00 b | 0.00 ± 0.00 c | 0.00 ± 0.00 c | 0.00 ± 0.00 b | 0.00 ± 0.00 b |
| NL/Mal - 1 in | 0.00 ± 0.00 a | 0.50 ± 1.00 a | 1.00 ± 1.15 b | 4.50 ± 3.00 c | 23.0 ± 9.31 b | 89.5 ± 8.06 a | 99.5 ± 1.00 a |
| NL/Mal - 5 in | 0.00 ± 0.00 a | 0.00 ± 0.00 a | 0.00 ± 0.00 b | 1.00 ± 2.00 c | 14.5 ± 5.00 bc | 88.5 ± 4.12 a | 100.0 ± 0.0 a |
| Polymer I -1 in | 0.50 ± 1.00 a | 2.50 ± 2.52 a | 14.0 ± 9.66 a | 41.0 ± 7.75 a | 68.0 ± 6.32 a | 92.5 ± 5.97 a | 99.5 ± 1.00 a |
| Polymer I - 5 in | 2.00 ± 2.83 a | 2.50 ± 3.79 a | 8.00 ± 3.65 ab | 24.5 ± 13.8 b | 55.0 ± 15.1 a | 92.0 ± 2.83 a | 100.0 ± 0.0 a |

^{z}Means in a column followed by the same letter are not significantly different using Tukeys HSD, α = 0.05.

TABLE 7b
(Mortality (% + S.D) of Caribfly after exposure to bait sprays)

| Treatment | 2 hr | 4 hr | 8 hr | 24 hr | 48 hr | 72 hr |
|---|---|---|---|---|---|---|
| control | 0.00 ± 0.00 a^{z} | 0.00 ± 0.00 a | 0.00 ± 0.00 c | 0.00 ± 0.00 c | 2.50 ± 1.91 d | 4.00 ± 3.27 b |
| NL/Mal - | 0.50 ± 1.00 a | 0.50 ± 1.00 a | 0.50 ± 1.00 c | 2.00 ± 2.31 c | 48.0 ± 18.8 c | 95.0 ± 3.46 a |
| 1 in | | | | | | |
| NL/Mal - | 0.00 ± 0.00 a | 0.00 ± 0.00 a | 0.00 ± 0.00 c | 0.50 ± 1.00 c | 56.0 ± 11.2 bc | 95.5 ± 3.42 a |
| 5 in | | | | | | |
| Polymer I - | 1.50 ± 1.00 a | 3.50 ± 3.42 a | 22.0 ± 3.65 a | 52.0 ± 11.2 a | 86.5 ± 11.2 a | 98.0 ± 1.63 a |
| 1 in | | | | | | |
| Polymer I - | 2.00 ± 1.63 a | 2.50 ± 2.52 a | 10.5 ± 8.54 b | 30.0 ± 5.89 b | 79.5 ± 12.6 ab | 99.0 ± 1.15 a |
| 5 in | | | | | | |

^{z}Means in a column followed by the same letter are not significantly different using Tukeys HSD, α = 0.05.

### EXAMPLE 8

Samples were prepared on glass slides. The bait spray compositions, number of droplets, were the same as in the previous experiment. A single simulated rainfall amount of 25 minutes (5 inches) was used. The NuLure®/malathion baseline formulation was completely washed-away by the simulated rainfall; whereas, the polymer enhanced bait spray formulation remained intact. There was some delamination of the polymer spots from the slick glass surface, which caused them to shift position slightly.

Prior to bioassay of these samples, it was realized that insect mortality could also be due to lack of a food source. Prior bioassays included NuLure®/malathion bait sprays and a 474 ml container of water which were placed in each cage. The water container was equipped with a lid with a hole, which accommodated two 9.8 mm diameter dental wicks, and provided drinking water to the flies as stated in the material and methods for insect bioassays. The importance of energy sustenance for the flies was realized after observation of high mortality after 24 hrs. To confirm this, additional tests were conducted with the same samples, with and without sugar water. As in the previous experiment, the bioassay was repeated using the same samples after an additional one week of storage. These bioassay results are shown in Tables 8a and 8b.

TABLE 8a
Mortality (% ± S.D) of Caribfly after exposure to bait spray

| Treatment | 2 hr | 4 hr | 8 hr | 24 hr | 48 hr | 72 hr | 96 hr |
|---|---|---|---|---|---|---|---|
| control | 0.00 ± 0.00 a^{z} | 0.00 ± 0.00 b | 0.00 ± 0.00 b | 0.00 ± 0.00 b | 0.00 ± 0.00 d | 0.00 ± 0.00 c | 0.00 ± 0.00 d |
| NL/M - Sugar | 0.00 ± 0.00 a | 0.00 ± 0.00 b | 0.00 ± 0.00 b | 0.00 ± 0.00 b | 4.00 ± 3.27 d | 7.50 ± 5.97 c | 10.5 ± 7.19 c |
| NL/M -water | 0.00 ± 0.00 a | 0.00 ± 0.00 b | 0.00 ± 0.00 b | 1.00 ± 2.00 b | 21.5 ± 9.85 c | 96.5 ± 3.00 a | 100.0 ± 0.0 a |
| Polymer - Sugar | 0.00 ± 0.00 a | 2.50 ± 1.91 a | 11.0 ± 7.75 a | 32.0 ± 4.32 a | 53.0 ± 4.16 b | 65.0 ± 3.46 b | 75.0 ± 3.46 b |
| Polymer -Water | 0.00 ± 0.00 a | 2.00 ± 1.63 ab | 11.0 ± 6.63 a | 34.0 ± 7.48 a | 78.5 ± 3.42 a | 98.0 ± 2.00 a | 100.0 ± 0.0 a |

^{z}Means in a column followed by the same letter are not significantly different using Tukeys HSD, α = 0.05.

TABLE 8b
Mortality (% + S.D) of Caribfly after exposure to bait spray

| Treatment | 2 hr | 4 hr | 8 hr | 24 hr | 48 hr | 72 hr | 96 hr |
|---|---|---|---|---|---|---|---|
| Control | 0.00 ± 0.00 a^{z} | 0.00 ± 0.00 b | 0.00 ± 0.00 b | 0.50 ± 1.00 b | 2.00 ± 1.63 c | 5.50 ± 1.91 c | 7.50 ± 1.00 c |
| NL/M - | 0.00 ± 0.00 a | 0.00 ± 0.00 b | 0.00 ± 0.00 b | 0.50 ± 1.00 b | 5.00 ± 2.58 c | 10.5 ± 3.00 c | 17.0 ± 6.83 c |
| Sugar | | | | | | | |
| NL/M -water | 0.00 ± 0.00 a | 0.00 ± 0.00 b | 0.00 ± 0.00 b | 1.00 ± 1.15 b | 55.5 ± 14.0 b | 95.5 ± 5.26 a | 100.0 ± 0.0 a |
| Polymer - | 1.00 ± 1.15 a | 2.00 ± 1.63 ab | 13.5 ± 1.91 a | 45.5 ± 5.51 a | 63.0 ± 6.00 b | 69.0 ± 6.22 b | 76.5 ± 7.72 b |
| Sugar | | | | | | | |
| Polymer - | 3.50 ± 3.42 a | 6.50 ± 4.43 a | 15.5 ± 10.5 a | 41.5 ± 10.1 a | 84.5 ± 4.12 a | 99.0 ± 1.15 a | 100.0 ± 0.0 a |
| Water | | | | | | | |

^{z}Means in a column followed by the same letter are not significantly different using Tukeys HSD, α = 0.05.

The data in Tables 8a-8b clearly show the effect of providing sugar to the insects. Thus, it appears that absorption of malathion into the polyethylene slides was not responsible for the results observed in Table 7. It is clear that the added polymer helps to stabilize the bait spray composition, and maintain its toxic effect—even after prolonged rain exposure and storage. When comparing only the treatments with sugar water provided (Tables 8a & 8b), it is apparent that the polymer-enhanced bait spray formulations were very effective in terms of increasing mortality of Caribbean fruit flies. At four days (Table 8a-96 hr observation), after post bait spray application and after five inches of simulated rain, the mortality for the standard bait NuLure®/malathion was only 10.5% as compared to 75% for the polymer-enhanced bait. The same bait spray formulation (polymer-sugar) performed well even seven (table 8b. 24 hr) and ten days (table 8b. 96 hr) later, with 45.5% and 76.5% vs. 0.5% and 17% for the standard spray formulation (NL/malathion) respectively.

### EXAMPLE 9

Experiments were performed to investigate the effects of various additives (polymeric and non-polymeric) on adhesion of the dried bait spray droplets to the polyethylene substrate when dry, and after 1 inch and 6 inch rainfall exposure. NuLure® attractant was used; however, malathion was not used in this investigation. The formulations tested are described below. A working solution of 1 part NuLure® to 3 parts 10% PVA was first prepared (NL/PVA). All compositions (except M-8) contained 15 g of NL/PVA solution in addition to the ingredients described below.

M-1: 5 g water

M-2: 5 g 10% cooked starch solution

M-3: 5 ml 20% PVP-co-AA polymer solution

M-4: 4 g water+1 g Silwet surfactant

M-5: 4 g water+1 g soluble oil spray

M-6: 4.75 g water+0.25 g n-hexanol

M-7: 4 g water+1 g 40% pDADMAC polymer

M-8: 15 g 10% cooked starch solution+5 g NL (no PVA)

Droplets were applied to polyethylene slides as described above (6×30 μL each), and allowed to air dry overnight. Slides were then exposed to 1 inch of simulated rainfall, then evaluated for adhesion while still wet. This process was then repeated after an additional 5 inches of simulated rainfall exposure.

It was observed that M-4, 5, and 6 spread out significantly more than the control formulation (lower surface tension) during (or shortly after) application to the substrate. After drying, it was observed that samples 3, 6, and 8 appeared to show improved adhesion compared to the control. This was estimated by lightly scraping the edge of the dried droplet with a small spatula. After 1 inch of simulated rainfall, it was observed that samples M-1, 2, and 6 showed the best adhesion. After 6 inches of simulated rainfall, it was observed that samples M-1, 2, 4, 5, and 6 showed the best adhesion; however, samples M-4, 5, and 6 had lost most of all of the brown NL color. Sample M-2 (starch) appeared to have the best overall adhesion in all cases, and was better than the control PVA formulation; however, starch alone (sample M-8) exhibited poor performance.

The main goal of this research project was realized in that a promising adjuvant approach was developed to achieve an environmentally safe, inexpensive, and rain-fast fruit fly bait spray. Observations of the polymer-enhanced bait spray compared to the standard formulation indicate that after 1 or even 5 (or more) inches of rain, water solubility was dramatically reduced. Furthermore, as shown by the insect bioassays results of Examples 1-2, the efficacy of material (persistent fly-killing power) was confirmed.

The examples illustrated herein describe the application of this invention to the control of particular insects on crops using particular insecticides specific crops; however, it will be apparent to one skilled in the art that the embodiments of this invention are applicable to a wide variety of pests, crops, and insecticides. For instance, the enhancing effects of the polymer adjuvant may be utilized in conjunction with fungicides, microbicides, herbicides, and the like, or the bait spray formulations in accordance with the present invention without the bail component.

Having generally described this invention, including the best mode thereof, those skilled in the art will appreciate that the present invention contemplates the embodiments of this invention as defined in the following claims, and equivalents thereof. However, those skilled in the art will appreciate that the scope of this invention should be measured by the claims appended hereto, and not merely by the specific embodiments exemplified herein. Those skilled in the art will also appreciate that more sophisticated technological advances will likely appear subsequent to the filing of this document with the Patent Office. To the extent that these later developed improvements embody the operative principles at the heart of the present disclosure, those improvements are likewise considered to come within the ambit of the following claims.

These and other advantages will be apparent from the disclosure of the invention(s) contained herein. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What I claim is:

1. An bait spray formulation comprising:
a bait component;
an insecticide component; and
an adjuvant effective to decrease a water solubility of the bait spray formulation upon drying of the bait spray formulation.

2. The bait spray formulation of claim 1, wherein the adjuvant is a polymer.

3. The bait spray formulation of claim 2, wherein the polymer is selected from the group consisting of a starch, carboxymethyl cellulose, poly(vinyl alcohol), and combinations thereof.

4. The bait spray formulation of claim 3, wherein the adjuvant is poly(vinyl alcohol), and wherein the poly(vinyl alcohol) is at least about 99% hydrolyzed.

5. The bait spray formulation of claim 1, wherein the adjuvant is water soluble when mixed with the bait component and the insecticide component to form the bait spray formulation, and is water insoluble upon drying of the bait spray formulation.

6. The bait spray formulation of claim 1, wherein the adjuvant is a water insoluble polymer.

7. The bait spray formulation of claim 6, wherein the water insoluble polymer is selected from the group consisting of poly(tetramethylene oxide), poly(caprolactone), a poly(acrylic acid) derivative, and combinations thereof.

8. The bait spray formulation of claim 1, wherein the adjuvant is poly(tetramethylene oxide) and the insecticide component is malathion, and wherein a ratio of poly(tetramethylene oxide) to malathion is from about 1:5 to about 1:1.

9. The bait spray formulation of claim 1, wherein the adjuvant is poly(tetramethylene oxide).

10. The bait spray formulation of claim 1, wherein the adjuvant comprises poly(vinyl alcohol) and poly(tetramethylene oxide).

11. The bait spray formulation of claim 1, further comprising an additive effective to increase a viscosity of the bait spray formulation.

12. The bait spray formulation of claim 1, further comprising an amount of citric acid effective to prevent gelling of the bait spray formulation.

13. The bait spray formulation of claim 1, wherein the insecticide is one or more of malathion and spinosad, and wherein the bait component comprises a protein hydrosylate.

14. A method for controlling the population of insects at a target area, comprising:
providing a bait spray formulation comprising a bait component, an insecticide component, and an adjuvant effective to decrease a water solubility of the bait spray formulation upon drying of the bait spray formulation;
applying an effective amount of the bait spray formulation to the target area effective to reduce a population of the insects.

15. The method of claim 14, wherein the adjuvant is a polymer selected from the group consisting of a starch, carboxymethyl cellulose, poly(vinyl alcohol), and combinations thereof.

16. The method of claim 15, wherein the polymer is water soluble when mixed with the bait component and the insecticide component to form the bait spray formulation, and is water insoluble upon drying of the bait spray formulation.

17. The method of claim 14, wherein the adjuvant is a water insoluble polymer selected from the group consisting of poly(tetramethylene oxide), poly(caprolactone), a poly(acrylic acid) derivative, and combinations thereof.

18. The method of claim 14, wherein the insects are Caribbean fruit fly insects.

20. A method for increasing the weather resistance of a bait spray formulation comprising a bait component and an insecticide component, comprising:
adding a polymer adjuvant to the bait spray formulation effective to decrease a water solubility of the bait spray formulation upon application to a target environment.

21. The method of claim 20, wherein the adjuvant is a polymer selected from the group consisting of a starch, carboxymethyl cellulose, poly(vinyl alcohol), and combinations thereof.

22. The method of claim 20, wherein the polymer is water soluble when mixed with the bait component and the insecticide component to form the bait spray formulation, and is water insoluble upon drying of the bait spray formulation.

23. The method of claim 20, wherein the adjuvant is a water insoluble polymer selected from the group consisting of poly(tetramethylene oxide), poly(caprolactone), a poly(acrylic acid) derivative, and combinations thereof.

24. The method of claim 20, wherein the insects are Caribbean fruit fly insects.
